(19) United States
(12) Patent Application Publication
(10) Pub. No.: US 2006/0153968 A1
(43) Pub. Date: Jul. 13, 2006

(54) Method of liquid-drop jet coating and method of producing display devices

(75) Inventor: Haruhiko Ishihara, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/268,577

(22) Filed: Nov. 8, 2005

(30) Foreign Application Priority Data
Nov. 9, 2004 (JP) 2004-325107

(51) Int. Cl. B05D 5/12; B05D 5/06; B05D 3/02

(52) U.S. Cl. 427/58; 427/66; 427/372.2

(57) ABSTRACT

Liquid-drops of a coating liquid, which contain a plurality of solvents having different boiling points, are jet coated onto a surface of a material to be coated. After that, the coating liquid coated on the surface of the coated material are heated while sequentially increasing a heating temperature according to each boiling point temperature of the plurality of solvents in the coating liquid, and are dried.

### CROSS-REFERENCE TO RELATED APPLICATION

This application is based upon and claims the benefit of priority from the prior Japanese Application No. 2004-325107, filed on Nov. 9, 2004; the entire contents of which are incorporated herein by reference.

### BACKGROUND OF THE INVENTION

1. Field of the Invention

The present invention relates to a method of liquid-drop jet coating and a method of producing display devices using this method, the method of liquid-drop jet coating being used in the process of coating a coating liquid onto a substrate and drying the coating to form a desired film on the substrate during production of semiconductor devices or a display devices that uses a thin display panel such as a liquid-crystal display panel, an organic EL (electroluminescence) display panel, or a field-emission display panel.

2. Description of Related Art

In production of semiconductor devices or display devices that use a thin display panel such as a liquid-crystal display panel, an organic EL display panel, or a field-emission display panel, liquid-drops of a coating liquid, containing aqueous solution and an inorganic or organic solvent, are jet coated onto the substrate from inkjet nozzles. The coating is dried to form a film of a functional layer and the like. Particularly, this inkjet coating method is suited to its use in forming film requiring fine patterning such as light-emission layers and color filter layers of display devices.

In a drying process of forming a solute (solid content) film from individual dots of coating liquid jetted onto the substrate in this inkjet coating method, conventionally, the liquid coated on the substrate is heated together with the substrate at a predetermined temperature.

However, according to the conventional drying process of heating and drying the coating at a constant temperature, it is difficult to control heat convection occurring inside the coating liquid. Because the coating liquid is dried starting from the end part in a radial direction, the center part tends to be swollen due to incrassation of the solution. Therefore, this introduces a risk that the uniformity of the film thickness distribution of the solidified material will be badly affected. Furthermore, when the coating liquid contains plural kinds of solvents having different boiling points, the coating liquid is often heated at a relatively high temperature, such as at or above the boiling point of a low-boiling point solvent, in order to volatilize the solvent sufficiently and promptly. Consequently, air bubbles of the low-boiling point solvent are generated in the coating liquid in the process of drying the coated liquid-drops, and the shape of the dried and solidified material tends to be deteriorated.

FIG. 1 is a schematic diagram of a coating liquid that is jetted in the above-described conventional drying process. As shown in FIG. 1, liquid-drops L that are jetted to a substrate S in the conventional drying process generate a convection inside the coating, as shown by arrow heads, due to the heating by a heater 1, depending on a kind of solvent and a drying condition. Due to this convection, the solidified material after the drying has a thick convex external shape having a large thickness at the center. The irregular distribution of a film thickness and irregular shape of the film tend to give negative influence to semiconductor devices or display devices that are produced. For example, the display devices cause an irregular light emission, when the distribution of the film thickness is non-uniform.

Japanese Patent Application Laid-open No. 2003-266003 discloses a method of producing a functional element by coating and drying a functional-layer formation liquid using an inkjet method or the like, wherein, in order to obtain flatness of the produced functional layer, a shape of the functional layer is checked, and the volatilization speed of the solvent in the drying process is increased or decreased according to the shape. When the functional layer has a convex shape, air sending and heating are arranged to increase the volatilization speed.

However, according to the method described above, shapes of individual functional layers formed on the substrate by the injection are checked in advance. The functional layers are dried with a method using constant drying conditions according to the result of the check. This method has a problem in that the shapes cannot be controlled sufficiently depending on the coating liquid. Particularly, the shape control is difficult when the coating liquid contains plural kinds of solvents.

### SUMMARY OF THE INVENTION

The present invention has been achieved to advantageously solve the above problems. It is an object of the invention to provide a method of liquid-drop jet coating capable of obtaining a solidified material or a film having a satisfactory distribution of film thickness, in coating the coating liquid onto a substrate by jetting the liquid-drops, and drying the coating liquid by heating, according to an inkjet coating method or the like, and provide a method of producing display devices to which the method of liquid-drop jet coating is applied.

The method of liquid-drop jet coating according to the present invention includes a step of coating liquid-drops of a jet of a coating liquid, containing plural solvents having different boiling points, onto the surface of a material to be coated, and drying the coating liquid with heating the coating liquid coated on the surface of the material to be coated, by sequentially increasing the heating temperature according to each boiling point of each of the plural solvents in the coating liquid, thereby sequentially volatilizing the solvents.

The method of producing display devices according to the present invention includes a steps of coating liquid-drops of a jet of a coating liquid, containing plural solvents having different boiling points, onto the surface of a substrate of the display device, and a drying process of heating the coating liquid coated on the surface of the substrate by sequentially increasing the heating temperature, according to each boiling point of each of the plural solvents in the coating liquid, thereby sequentially volatilizing the solvents.

According to the present invention, the liquid-drops of the coating liquid jetted to the material to be coated are dried satisfactorily, thereby obtaining a uniform film-thickness distribution.

### BRIEF DESCRIPTION OF THE DRAWINGS

FIG. 1 is a schematic diagram of a coating liquid that is jetted in a conventional drying process;

FIG. 2 is a flowchart of a method of liquid-drop jet coating according to one embodiment of the present invention;

FIG. 3 is a graph showing a time series change of a drying temperature and a solvent drying quantity in the drying process in the method of liquid-drop jet coating according to the embodiment; and

FIG. 4 is a block diagram of one example of a coating and drying device that can be used in the method of liquid-drop jet coating according to the embodiment.

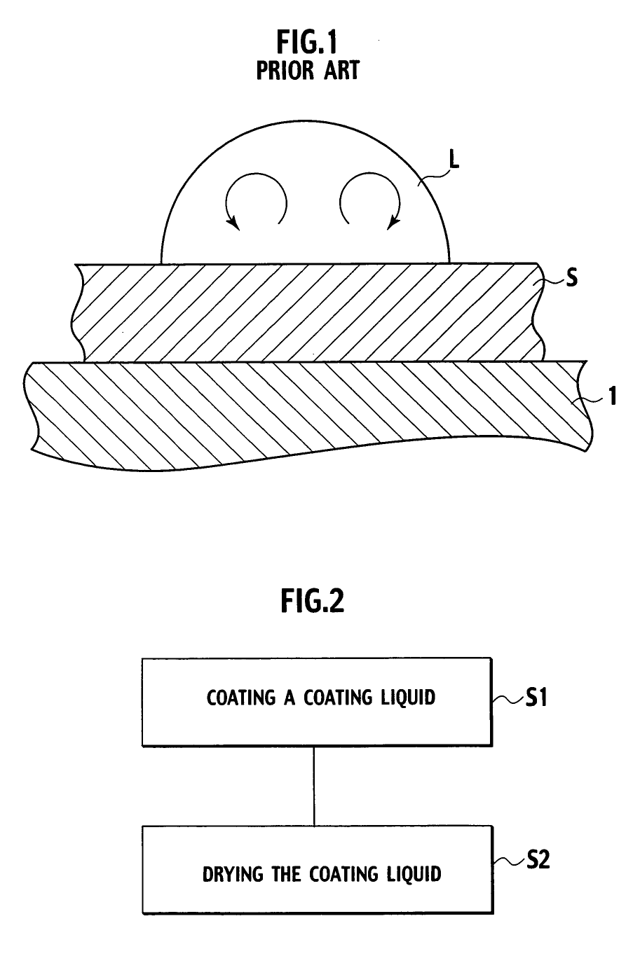

### DETAILED DESCRIPTION OF THE INVENTION

FIG. 2 is a flowchart of a method of liquid-drop jet coating according to one embodiment of the present invention. As shown in FIG. 2, in the method of liquid-drop jet coating according to one embodiment of the invention, a coating process of injecting liquid-drops of a coating liquid, containing plural solvents, onto the surface of a material to be coated is carried out (step S1). The coating liquid used in the coating process includes a solute to form a film by drying, and a solvent that solves or disperses the solute, as main components. The solute includes an organic material for a light-emission layer of a display device, and a pigment for a coloring layer of a color filter. The solvent includes water, alcohol, and various kinds of organic solvents. The coating liquid that contains the solute and the solvent is accommodated in a tank of the inkjet coating device. The coating liquid is led from the tank to a nozzle provided on an inkjet head. Liquid-drops of the coating liquid are jetted from this nozzle, thereby coating the coating liquid onto the surface of the material to be coated.

When the nozzle of the inkjet coating device is jammed, a proper coating cannot be carried out in a predetermined area of the material to be coated. This results in a defective product having a film formed by the inkjet coating method. Therefore, the jamming of the nozzle must be avoided as much as possible. In order to avoid occurrences of the jamming of the nozzle due to the drying and solidification of the coating liquid (ink) at the front end or the inside of the nozzle, the coating liquid used for the inkjet coating contains plural kinds of solvents having different boiling points.

After the above coating process, a drying process of volatilizing and drying the coating liquid coated on the surface of the material to be coated is carried out (step S2 in FIG. 2). In this drying process, a film of a solidified material of the solute is formed on the surface of the material to be coated. While heating, depressurizing, and blowing are used as means for the drying process, the drying based on heating is used in many cases in practice, because of a simple device used as compared with those used in other methods. Conventionally, in the drying process of volatilizing the coating liquid by heating, the heating is carried out at a constant temperature near the boiling point of the lowest-boiling point solvent or a higher temperature among the plural solvents contained in the coating liquid, in order to improve the work efficiency by shortening the drying time from the start to the end of drying. According to this conventional drying process, it is difficult to control the occurrence of heat convection and air bubbles inside the coating liquid. Consequently, the distribution of the film thickness after solidification by drying becomes non-uniform, as described above.

The method of liquid-drop jet coating according to the present invention includes a drying process of heating the coating liquid coated on the surface of the material to be coated, by sequentially increasing the heating temperature according to each boiling point of each of the plural solvents in the coating liquid, thereby sequentially volatilizing the solvents. Because the solvents can be volatilized at a heating temperature equal to or lower than each boiling point of each solvent, the heat convection and air bubbles that occur inside the coating liquid can be suppressed, and a solidified material having a uniform film-thickness distribution can be obtained. Furthermore, by sequentially increasing the heating temperature, a total drying time can be shortened as compared to the conventional time. As a result, work efficiency can be improved further.

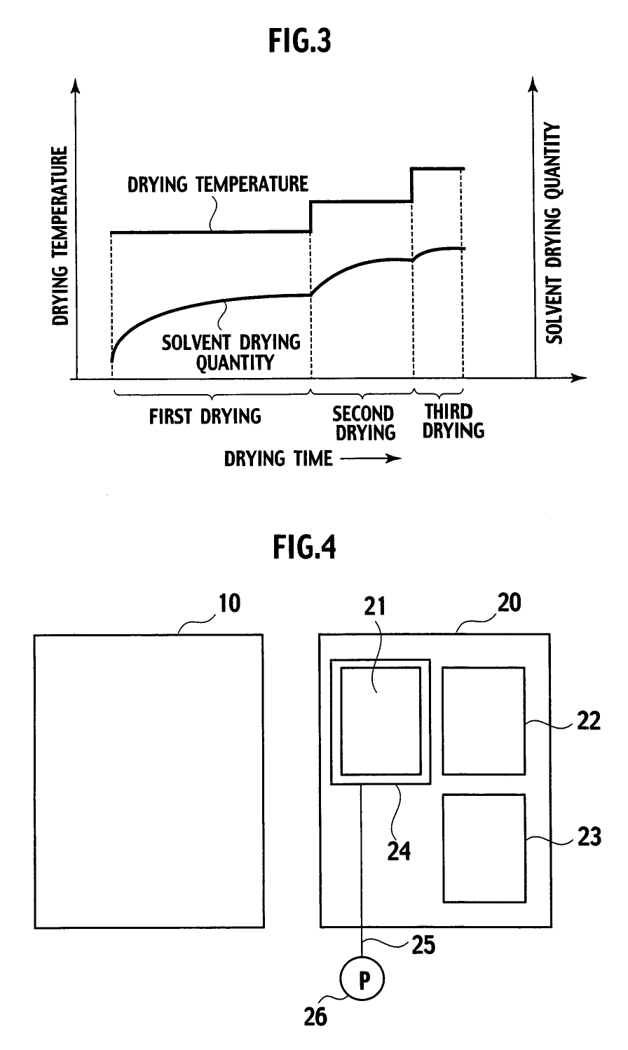

One example of the drying process according to the present invention is explained with reference to FIG. 3. FIG. 3 is a graph showing a time series change of a drying temperature and a solvent drying quantity in the drying process. In this example, the coating liquid contains three kinds of solvents having different boiling points. A heating temperature (a drying temperature) is increased at plural stages of temperatures. At a first drying stage, the heating temperature is set to a temperature lower than the boiling point of a solvent having a lowest boiling point among those of the solvents contained in the coating liquid. For example, when the coating liquid contains solvents of water (whose boiling point is 100° C.), ethylene glycol (whose boiling point is 198° C.), and glycerin (whose boiling point is 290° C.), the heating temperature during the first drying period is set to about 80 to 90° C. With this arrangement, the solvents are slowly dried and volatilized, without being boiled. Therefore, the occurrence of heat convection inside the coating liquid can be suppressed.

When the drying quantity of the solvent having the lowest boiling point is saturated, that is, when the volatilization of the solvent having the lowest boiling point is substantially completed or is completed, the drying shifts to second drying. At this stage, the drying temperature is set to a temperature higher than the boiling point of the solvent having the lowest boiling point and is lower than the boiling point of the solvent having a second lowest boiling point. For example, when the solvents in the coating liquid include water, ethylene glycol, and glycerin as described above, the heating temperature during the second heating period is set to about 120 to 150° C. With this arrangement, the solvents are slowly dried and volatilized, without being boiled, during the second drying. Therefore, the occurrence of heat convection inside the coating liquid can be suppressed. Because the heating temperature is increased from that during the first drying period, the total drying time can be shortened from that when the coating liquid is dried at a constant temperature used in the first drying period from the start of the drying till the end of the drying. During the second drying period, when the fluidity of the coating liquid that remains after the solvent having a highest boiling point during the first drying period becomes small, the heating temperature is set to a boiling point or higher than that of the solvent having the second-lowest boiling point, thereby further shortening the drying time.

When the drying quantity of the solvent having the second-lowest boiling point is saturated, that is, when the volatilization of the solvent having the second-lowest boiling point is substantially completed or is completed, the drying shifts to third drying. During the third drying, the drying temperature is set higher than the temperature during the second drying period. For example, when the solvents in the coating liquid include water, ethylene glycol, and glycerin as described above, the heating temperature during the third heating period is set to about 180° C. Glycerin is usually contained by an extremely small quantity in the coating liquid. For example, when a volume proportion of glycerin in the coating liquid is one, the volume proportion of ethylene glycol is 30, and that of water is 70. In other words, the volume proportion of glycerin in the total coating liquid is only about one hundredth. Therefore, when water and ethylene glycol are volatilized after ending the second drying, the fluidity of the coating liquid is substantially lost. Consequently, when the solvents include water, ethylene glycol, and glycerin as described above, the heating temperature during the third drying period when glycerin is volatilized has little influence. However, when the heating temperature during the third drying period is set higher than the heating temperature during the second drying, the drying time can be further shortened. At the third heating stage, needless to mention, the heating can be carried out at the heating temperature higher than the boiling point of the solvent having the second-lowest boiling point, lower than the boiling point of the solvent having the third-lowest boiling point, or equal to or higher than the boiling point of the solvent having the third-lowest boiling point.

In the method of liquid-drop jet coating according to the embodiment of the present invention, it is more preferable to use a coating liquid that contains most the solvent having the lowest boiling point among plural solvents. The coating liquid that contains most the solvent having the lowest boiling point means that the coating liquid contains most the solvent that can be dried easily. In this case, the use of the coating liquid that contains the solvent having the lowest boiling point most at the first drying stage has little influence on the drying time. At the second drying stage, the fluidity of the coating liquid is already extremely lowered because the solvent having the lowest boiling point is already volatilized. Therefore, the heating at a relatively high temperature can be achieved during the second drying and the third drying. Consequently, the total drying time can be shortened.

While the heating is carried out at three stages in the example shown in FIG. 3, it can be carried out at two stages or at four or more stages depending on the solvents used. While the heating is carried out at constant temperatures at the first drying stage, the second drying stage, and the third drying stage respectively in the example shown in FIG. 3, the heating temperature can be increased linearly or in a curve during each drying process. According to a drying device described below, drying is carried out by heating at stages as shown in FIG. 3.

FIG. 4 is a block diagram of one example of a coating and drying device that can be used in the method of liquid-drop jet coating according to the embodiment of the present invention. In FIG. 4, a drying device 20 is provided adjacently to an inkjet drying device 10. The drying device 20 includes a first heater 21, a second heater 22, and a third heater 23. These heaters 21, 22, and 23 are set to different temperatures respectively depending on the boiling temperatures of solvents contained in the coating liquid to be dried. Specifically, the heating temperature for the first drying process is set to the first heater 21, the heating temperature for the second drying process is set to the second heater 22, and the heating temperature for the third drying process is set to the third heater 23. Specifically, these heaters 21, 22, and 23 can be hotplates, or can be heating furnaces capable of accommodating plural materials to be processed.

The inkjet coating apparatus 10 coats a coating liquid onto a material (not shown), and conveys the coated material onto the first heater 21 of the drying device 20. The first heater 21 heats the coated material at the heating temperature for the first drying process. After ending the first drying, the inkjet coating apparatus 10 shifts the coated material from the first heater 21 to the second heater 22, and the second heater 22 heats the coated material at the heating temperature for the second drying process. After ending the second drying, the inkjet coating apparatus 10 shifts the coated material from the second heater 22 to the third heater 23, and the third heater 23 heats the coated material at the heating temperature for the third drying process. As explained above, plural heaters are provided inside the drying device, and the respective heating temperatures of the heaters are set to the heating temperatures for the first drying process, the second drying process, and the third drying process. The coated material is sequentially shifted to these heaters, and is dried. With this arrangement, plural coated materials can be dried sequentially, without requiring the time to drop the heating temperature of the third drying process to the heating temperature of the first drying process using one heater, like the process of drying the coated materials by sequentially increasing the heating temperature of the first drying process to the heating temperature of the second drying process, and to the heating temperature of the third drying process respectively using one heater. As a result, productivity can be improved.

In the method of liquid-drop jet coating according to the embodiment of the present invention, during the drying process, at least during the volatilization of the solvent having the lowest boiling point, the drying can be performed under reduced pressure. The drying device 20 shown in FIG. 4 has a processing chamber 24 that can be hermetically sealed, for accommodating the first heater 21. An exhaust system (a pump) 26 is connected to this processing chamber 24 via a pipe 25. A pressure controller (not shown) can keep the inside of the processing chamber 24 at a predetermined reduced pressure. Depending on the kind of a coating liquid, it is difficult to control the drying state when the coating liquid is dried based on only heating. In this case, when the first drying process includes heating and pressure reduction, the drying state can be controlled more easily than when the drying is carried out by heating in the atmosphere. When the drying is carried out in the reduced atmosphere, the heating temperature can be set relatively lower.

In the example shown in FIG. 4, while the first heater 21 carries out heating in the atmosphere of reduced pressure, in the drying process according to the embodiment of the invention, in addition to the first heater 21, either one or both of the second heater 22 and the third heater 23 can also carry out heating in the atmosphere of reduced pressure.

The method of liquid-drop jet coating according to the embodiment of the invention is advantageously applied to the coating using a coating liquid in which three or more kinds of solvents having different boiling points are mixed.

The method of liquid-drop jet coating according to the embodiment of the invention is advantageously applied to the coating when each of liquid-drops coated onto the surface of the material to be coated has a diameter of 1 mm or less. The coating, when a liquid-drop coated onto the surface of the material to be coated has a diameter of 1 mm or less, is performed by an inkjet coating device. When the coating liquid that has this diameter of the liquid-drop is dried by the method according to the embodiment of the invention, a film having a uniform distribution of film thickness can be obtained.

In a production of display devices, there is a process of forming a light-emitting element layer of an organic EL panel, and a colored layer or a black-matrix layer of a color filter of a liquid-crystal panel, on the substrate of the display devices. These layers need to be formed within an area partitioned minutely. Therefore, the method of liquid-drop jet coating according to the invention can be used to coat and dry a coating liquid by jet ink coating, thereby forming a light-emitting film of a light-emitting element or a colored film of a color filter or a light-shielding film.

Specifically, in a production of a liquid-crystal display as a display device, a thin-film transistor (TFT) array substrate having TFTs regularly arranged on a glass substrate is produced. At the same time, a color filter substrate having a color filter and a black matrix formed on other glass substrate is produced. The TFT array substrate and the color filter substrate are bonded together. A liquid-crystal material is injected into a gap between the bonded substrates, and is sealed, thereby obtaining a panel substrate. Alternatively, in order to obtain the panel substrate, both of a color filter and a black matrix can be formed on the TFT array substrate.

In a production of the color filter substrate or the TFT array substrate having the color filter and the black matrix formed together, in order to form a colored layer corresponding to each luminescent spot (a sub-pixel) of the color filter layer, or in order to form a light-shielding layer (a black matrix) for shielding a non-display area provided around the display area formed by luminescent spots or between the luminescent spots, a film can be formed by the method of liquid-drop jet coating according to the invention.

### EXAMPLE

A pigmented ink containing solvents, including glycerin by one as a volume proportion, ethylene glycol by 30 as a volume proportion, and water by 70 as a volume proportion, is coated on a substrate. As shown in FIG. 3, the pigmented ink is heated at 80° C. for five minutes in the first drying process, is heated at 120° C. for three minutes in the second drying process, and is heated at 180° C. for one minute in the third drying process, thereby drying the pigmented ink. As a result, a film having a satisfactory distribution of film thickness can be obtained. On the other hand, the pigmented ink which is the same as the above pigmented ink is coated on the substrate, and is dried by heating at 120° C. As a result, remarkable heat convection occurs in the drying process. Consequently, the obtained film has a variation in the film-thickness distribution.

What is claimed is:

1. A method of liquid-drop jet coating, comprising steps of:
coating liquid-drops of a jet of a coating liquid, containing a plurality of solvents having different boiling points, onto a surface of a material to be coated; and
drying the coating liquid, by sequentially volatilizing the coating liquid coated on the surface of the coated material with heating the coating liquid while sequentially increasing a heating temperature according to each boiling point temperature of the plurality of solvents.

2. The method of liquid-drop jet coating according to claim 1, wherein the coating liquid contains a solvent having a lowest boiling point at a largest ratio among the plurality of solvents having different boiling points.

3. The method of liquid-drop jet coating according to claim 1, wherein the heating temperature is set to a temperature lower than a boiling point of a solvent having a lowest boiling point among the solvents contained in the coating liquid, thereby sequentially increasing the temperature.

4. The method of liquid-drop jet coating according to claim 1, wherein, during the drying process, the drying is performed in the atmosphere of reduced pressure while at least a solvent having a lowest boiling point is being volatilized.

5. The method of liquid-drop jet coating according to claim 1, wherein a coating liquid containing three or more kinds of solvents having different boiling points is used.

6. A method of producing display devices, comprising steps of:
coating liquid-drops of a jet of a coating liquid, containing a plurality of solvents having different boiling points, onto the surface of a substrate of the display devices; and
drying the liquid-drops, by sequentially volatilizing the coating liquid coated on the surface of the substrate with heating the coated liquid while sequentially increasing a heating temperature according to each boiling point temperature of the plurality of solvents.

7. The method of producing display devices according to claim 6, wherein at least one of a light-emitting film of a light-emitting element, a colored film of a color filter, and a light-shielding film of the color filter is formed by carrying out the coating process and the drying process.
